(19) United States
(12) Patent Application Publication
(10) Pub. No.: US 2024/0144743 A1
(43) Pub. Date: May 2, 2024

(54) TRANSDUCER-BASED SUSPENSION HEALTH MONITORING SYSTEM

(71) Applicant: GM Cruise Holdings LLC, San Francisco, CA (US)

(72) Inventors: Jeffrey Robert Brandon, Phoenix, AZ (US); David Tran, San Francisco, CA (US)

(21) Appl. No.: 17/979,684

(22) Filed: Nov. 2, 2022

(51) Int. Cl. G07C 5/04; G07C 5/00

(52) U.S. Cl. CPC G07C 5/04; G07C 5/008

(57) ABSTRACT

The disclosed technology provides solutions for efficiently and accurately identifying degraded suspension components. A method of the disclosed technology can include steps for associating a threshold measurement to a road feature; collecting sensor data from a sensor on an autonomous vehicle, wherein the sensor data includes a plurality of measurements associated with the road feature; identifying, from the sensor data, at least one measurement that is outside of the threshold measurement and indicative of a degraded suspension component of the autonomous vehicle; and identifying a location on the autonomous vehicle of the degraded suspension component based on the sensor data. Systems and machine-readable media are also provided.

### BACKGROUND

### 1. Technical Field

The disclosed technology provides solutions for identifying degraded suspension components and in particular, provides methods for improving the detection and reporting of degraded suspension components by processing sensor data to identify certain signatures that are indicative of degraded suspension components.

### 2. Introduction

Autonomous vehicles are vehicles having computers and control systems that perform driving and navigation tasks that are conventionally performed by a human driver. An exemplary autonomous vehicle utilizes various sensor systems, such as a camera sensor system, a radar sensor system, an accelerometer sensor system, amongst others, to control mechanical systems of the autonomous vehicle, such as a vehicle propulsion system, a braking system, or a steering system. Certain mechanical components of the autonomous vehicle may degrade over time, such as components of a suspension system. Conventionally, such systems are inspected at a pre-determined interval of time or mileage to identify and replace any degraded components. Such inspections, however, result in vehicle downtime and are costly, time consuming, and inefficient.

### BRIEF DESCRIPTION OF THE DRAWINGS

Certain features of the subject technology are set forth in the appended claims. However, the accompanying drawings, which are included to provide further understanding, illustrate disclosed aspects and together with the description explain the principles of the subject technology. In the drawings:

FIG. 1 illustrates an example system environment for operating an autonomous vehicle in communication with a remote data center, according to some aspects of the disclosed technology.

FIG. 2 illustrates a block diagram of an example autonomous vehicle utilizing a transducer-based suspension health monitoring system, according to some aspects of the disclosed technology.

FIG. 3 illustrates an example method for detecting degraded suspension components, according to some aspects of the disclosed technology.

FIG. 4 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring certain concepts.

An autonomous vehicle (AV) is a motorized vehicle that can navigate without a human driver. An exemplary autonomous vehicle utilizes various sensor systems, such as a camera sensor system, a radar sensor system, an accelerometer sensor system, amongst others, to control mechanical systems of the autonomous vehicle, such as a vehicle propulsion system, a braking system, or a steering system. Certain mechanical components of the autonomous vehicle may degrade over time, such as components of a suspension system. Conventionally, such systems are inspected at a pre-determined interval of time or mileage to identify and replace any degraded components. Such inspections, however, result in vehicle downtime and are costly, time consuming, and inefficient.

The disclosed technology addresses the need for an efficient and accurate process for detecting degraded suspension components. As will be discussed in further detail below, the autonomous vehicle may determine through sensor data and map data, the presence of a degraded suspension component.

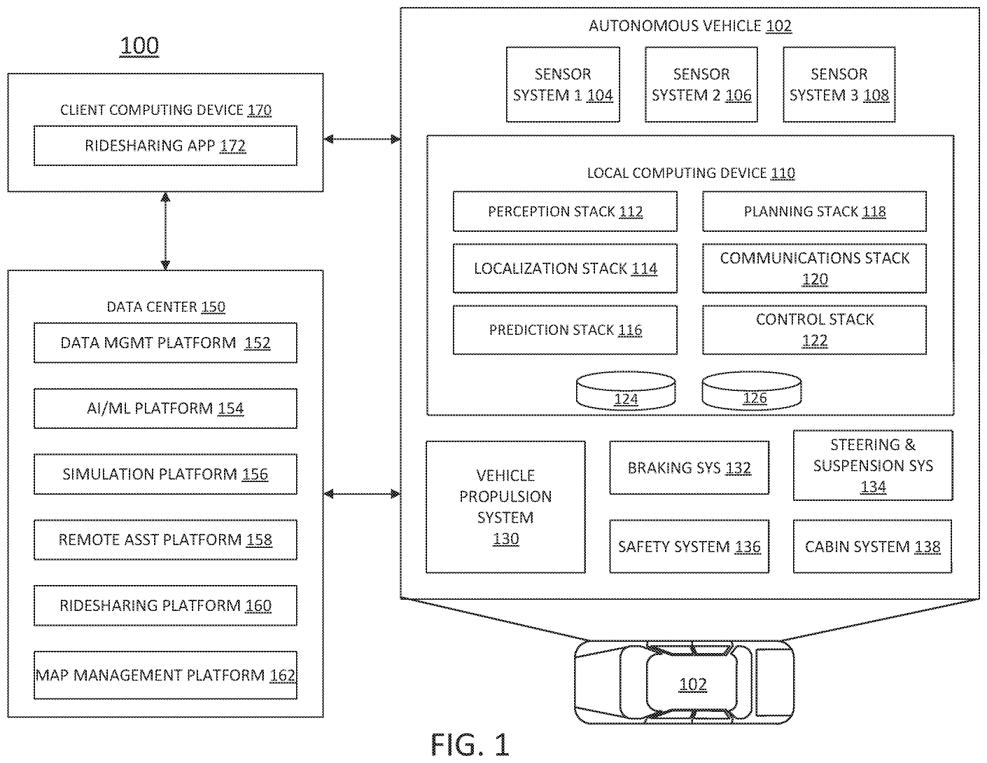

FIG. 1 illustrates an example system environment 100 for operating an AV in communication with a remote data center, according to some aspects of the disclosed technology. One of ordinary skill in the art will understand that, for the system environment 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the system environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), optical sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be an accelerometer system, the sensor system 106 can be an audio system, and the sensor system 108 can be a camera system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering and suspension system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering and suspension system 134 can include suitable componentry configured to control the direction of movement of the AV 102 during navigation and further includes suspension components such as shock absorbers, springs, bearings, bushings, and other components that are designed to dampen road bumps and holes to provide a safe and comfortable ride. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Mapping and localization stack 114 can determine the AV's position and orientation (pose) using different methods from multiple systems (e.g., GPS, IMUs, accelerometers, cameras, microphones, LIDAR, RADAR, ultrasonic sensors, the HD geospatial database 126, etc.). For example, in some embodiments, AV 102 can compare sensor data captured in real-time by sensor systems 104-108 to data in HD geospatial database 126 to determine its precise (e.g., accurate to the order of a few centimeters or less) position and orientation. AV 102 can focus its search based on sensor data from one or more first sensor systems (e.g., GPS) by matching sensor data from one or more second sensor systems (e.g., LIDAR). If the mapping and localization information from one system is unavailable, AV 102 can use mapping and localization information from a redundant system and/or from remote data sources.

Prediction stack 116 can receive information from localization stack 114 and objects identified by perception stack 112 and predict a future path for the objects. In some embodiments, prediction stack 116 can output several likely paths that an object is predicted to take along with a probability associated with each path. For each predicted path, prediction stack 116 can also output a range of points along the path corresponding to a predicted location of the object along the path at future time intervals along with an expected error value for each of the points that indicates a probabilistic deviation from that point.

Planning stack 118 can determine how to maneuver or operate AV 102 safely and efficiently in its environment. For example, planning stack 118 can receive the location, speed, and direction of AV 102, geospatial data, data regarding objects sharing the road with AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. Planning stack 118 can determine multiple sets of one or more mechanical operations that AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct AV 102 to go around the block instead of blocking a current lane while waiting for an opening to change lanes.

Control stack 122 can manage the operation of the vehicle propulsion system 130, the braking system 132, the steering and suspension system 134, the safety system 136, and the cabin system 138. Control stack 122 can receive sensor signals from the sensor systems 104-108 as well as communicate with other stacks or components of the local computing device 110 or a remote system (e.g., the data center 150) to effectuate operation of AV 102. For example, control stack 122 can implement the final path or actions from the multiple paths or actions provided by planning stack 118. This can involve turning the routes and decisions from planning stack 118 into commands for the actuators that control the AV's steering, throttle, brake, and drive unit.

Communications stack 120 can transmit and receive signals between the various stacks and other components of AV 102 and between AV 102, data center 150, client computing device 170, and other remote systems. Communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, presence of potholes or speed bumps, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 124 can store raw AV data generated by the sensor systems 104-108, stacks 112-122, and other components of AV 102 and/or data received by AV 102 from remote systems (e.g., data center 150, client computing device 170, etc.). In some embodiments, the raw AV data can include HD LIDAR point cloud data, image data, RADAR data, GPS data, accelerometer data, and other sensor data that data center 150 can use for creating or updating AV geospatial data or for creating simulations of situations encountered by AV 102 for future testing or training of various machine learning algorithms that are incorporated in local computing device 110.

Data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. Data center 150 can include one or more computing devices remote to local computing device 110 for managing a fleet of AVs and AV-related services. For example, in addition to managing AV 102, data center 150 may also support a ridesharing service, a delivery service, a remote/roadside assistance service, street services (e.g., street mapping, street patrol, street cleaning, street metering, parking reservation, etc.), and the like.

Data center 150 can send and receive various signals to and from AV 102 and client computing device 170. These signals can include sensor data captured by the sensor systems 104-108, roadside assistance requests, software updates, ridesharing pick-up and drop-off instructions, and so forth. In this example, data center 150 includes a data management platform 152, an Artificial Intelligence/Machine Learning (AI/ML) platform 154, a simulation platform 156, a remote assistance platform 158, and a ridesharing platform 160, and a map management platform 162, among other systems.

Data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

AI/ML platform 154 can provide the infrastructure for training and evaluating machine learning algorithms for operating AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

Simulation platform 156 can enable testing and validation of the algorithms, machine learning models, neural networks, and other development efforts for AV 102, remote assistance platform 158, ridesharing platform 160, map management platform 162, and other platforms and systems. The simulation platform 156 can replicate a variety of driving environments and/or reproduce real-world scenarios from data captured by AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

Remote assistance platform 158 can generate and transmit instructions regarding the operation of the AV 102. For example, in response to an output of the AI/ML platform 154 or other system of data center 150, remote assistance platform 158 can prepare instructions for one or more stacks or other components of AV 102.

Ridesharing platform 160 can interact with a customer of a ridesharing service via a ridesharing application 172 executing on client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing ridesharing application 172. Client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of data center 150. For example, the AI/ML platform 154 may incorporate the map viewing services for visualizing the effectiveness of various object detection or object classification models, simulation platform 156 may incorporate the map viewing services for recreating and visualizing certain driving scenarios, remote assistance platform 158 may incorporate the map viewing services for replaying traffic incidents to facilitate and coordinate aid, ridesharing platform 160 may incorporate the map viewing services into client application 172 to enable passengers to view AV 102 in transit en route to a pick-up or drop-off location, and so on.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

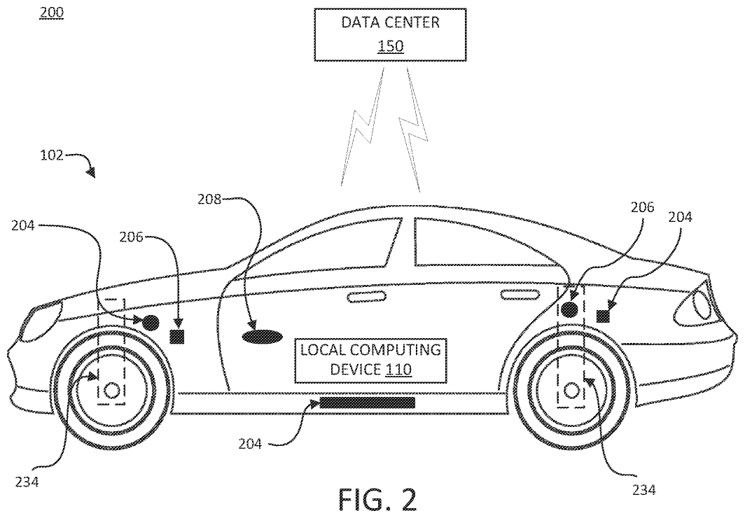

FIG. 2 illustrates a block diagram of an AV 102 utilizing a transducer-based suspension health monitoring system 200, according to some aspects of the disclosed technology. The suspension health monitoring system 200 includes one or more sensors, such as three-axis accelerometers 204, microphones 206, and camera/s 208. The sensors 204-208 can be mounted to a body (or body panel) of the AV 102. In one example, accelerometers 204 and microphones 206 may be mounted within (or in proximity to) a corresponding suspension system 234. Suspension system 234 includes suspension components such as shock absorbers, springs, bearings, bushings, and/or other components designed to dampen road bumps and holes to provide a safe and comfortable ride. Sensor data is provided to the local computing device 110 via communications stack 120. As discussed further below, perception stack 112 may be configured to receive location data from the mapping and localization stack 114 to identify known road features, such as speed bumps, and by using sensor data received from sensors 204-208, can be further configured to determine whether one or more measurements from sensors 204-208 is out of range or exceeds a predetermined threshold that is indicative of a degraded suspension component.

In some aspects, data from sensors 204-208 can be compared to known (baseline) or ground-truth sensor data to determine an operating state of the suspension system 234 and/or an operating state of one or more shock absorbers used therein. For example, audio data collected by microphones and/or image data collected by cameras can be compared with sensor data collected by similar vehicles (e.g., with similar suspension systems) to determine an operating state (e.g., healthy or degraded) of the vehicle suspension system. In some aspects, comparisons between collected sensor data may be made using data that is collected by similar vehicles (e.g., those with similar suspension system or suspension configurations) and/or with vehicles operated in similar environments. By way of example, sensor data collected for a vehicle operated in a particular geographic location may be compared to other vehicles in the same (or a similar location) and/or with vehicles of a similar type or configuration.

In some instances, collected sensor data may be sent to data center 150 via communications stack 120 for processing in data management platform 152. Sensor data may be ingested by AI/ML platform 154 to identify (classify) signal signatures that represent degraded suspension components. Sensor data may thus be used by AI/ML platform 154 to train and evaluate machine learning algorithms for identifying the presence of a degraded suspension component and the location of the degraded suspension component with respect to the corresponding AV 102, such as front-left, front-right, rear-left, or rear-right suspension component, etc.

Degraded suspension components respond to road artifacts, such as speed bumps or potholes differently in period and frequency of oscillations when compared to their healthy counterparts. For example, a degraded shock absorber may be unable to return to its nominal state within a certain time period, signifying that the shock absorber lacks adequate return force to return the shock to its nominal state. Alternatively, a shock absorber may altogether fail to provide any dampening effect, thereby resulting an oscillation of a spring for prolonged periods of time, thereby also signifying a failed shock absorber. The response characteristics of a particular suspension component may therefore be ascertained using an accelerometer 204 that is configured to measure the frequency and periodic oscillation of a suspension system 234.

As another example, a degraded shock absorber may generate an audio signature indicative of its deteriorated state. For instance, a shock absorber that lacks adequate return force may “bottom out” thereby resulting in an audible event that may be characterized as sudden and low in frequency. Such characteristics could be used to assign an audio signature for various degradation modes that are indicative of a deteriorating suspension system that could be captured by a microphone 206. In addition, a degraded shock absorber may result in a jolted or otherwise a bumpy ride experience thereby resulting in images captured by a camera 208 to have degraded quality such as blurred images due to the lack of dampening or shock absorption provided by a degraded suspension system.

Using the AI/ML platform 154, data scientists can prepare data sets from sensors 204-208; select, design, and train machine learning models; evaluate, refine, and deploy the models; maintain, monitor, and retrain the models; and so on in order to identify threshold measurements and/or measurement signatures indicative of degraded suspension components, as well as identify nominal ranges for healthy suspension systems, and identify locations of degraded suspension components within a particular AV. In addition, the AI/ML platform 154 may generate algorithms (or models) that are trained from a collection of historical sensor data received from various AVs that represent measurements associated with healthy and degraded suspension components. The historical sensor data may be labeled with classifications based on a level or degree of degradation for a particular suspension component.

In some aspects, models used to identify degraded suspension signatures (e.g., based on received/inputted sensor data) may be geolocation specific. For example, models may be trained on sensor data from vehicles in a particular geolocation, or that is received from vehicles implemented for a particular use. As such, collected sensor data for a given vehicle can be used to identify degraded suspensions states with respect to similar vehicles and/or those operated in similar environments, such as roadways that experience heavy traffic or are regularly exposed to certain environmental conditions (e.g., ice, salt, etc.).

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

In one aspect, the algorithms may be used by the local computing device 110 to automatically identify degraded suspension components based on measurements provided by sensors 204-208, and may also be used by the local computing device 110 to identify a location of a degraded suspension component. In another aspect, the data center 150 may utilize the algorithms to automatically identify degraded suspension components on a particular AV based on measurements provided by sensors 204-208. The data center 150 may also use the algorithms to identify a location of a degraded suspension component within a particular AV.

In some aspects, remote assistance platform 158 can generate and transmit maintenance instructions requesting inspection or replacement of the degraded suspension component. In another aspect, local computing device 110 may generate maintenance instructions requesting inspection or replacement of the degraded suspension component.

In operation, mapping data is processed to identify known road features that may solicit an excitation from sensors 204-208. Road features may include speed bumps, potholes, or other road features that are expected to generate measurements from sensors associated with the suspension system. The known road features have nominal measurement ranges assigned that reflect a normal suspension response. The nominal ranges may be derived from sensor data received from other AVs 102 thereby providing a baseline measurement that the measurements of AV 102 may be measured or compared against. When AV 102 encounters the known road feature, such as a speed bump or pothole, measurement data from sensors 204-208 is processed to determine whether the measurements fall outside of the assigned nominal ranges. As the AV 102 drives over the speed bump or pothole, the sensors 204-208 output measurements corresponding to the various sensors. For example, the accelerometers 204 detect frequency and period of oscillation of the AV 102. In some aspects, the sensor 204 may also include an inertial measurement unit (IMU). Initial detection of a degraded suspension component may also be validated using sensor data from other sensors, such as microphones 206 and/or camera 208. Audio signals provided by microphones 206 may be processed to identify signatures indicative of a degraded or failing suspension component. If found, the likelihood that there is indeed a degraded suspension component is significantly improved. Similarly, if image data shows a jolt or abrupt displacement of the AV 102 in response to a speed bump or pot hole, the likelihood that there is indeed a degraded or failing suspension component is greatly increased. Image data that may be indicative of a failing or degraded suspension component will likely include blurred images due to the abrupt nature of the resulting ride experience.

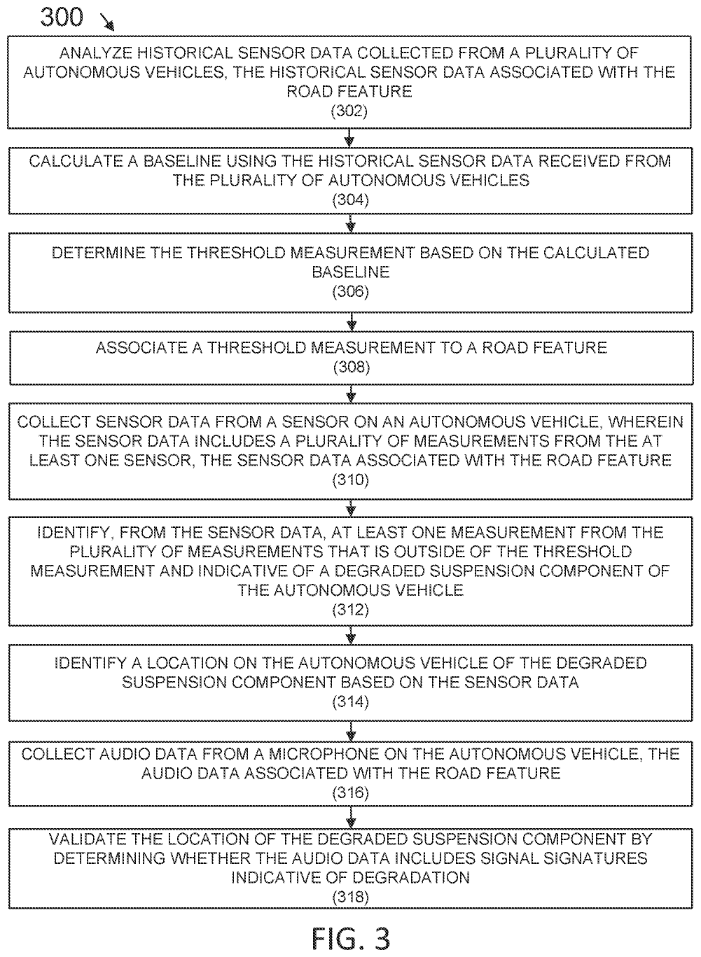

FIG. 3 illustrates an example method 300 for detecting degraded suspension components, according to some aspects of the disclosed technology. The method 300 begins with step 302, in which historical sensor data collected from a plurality of autonomous vehicles is analyzed to identify data that is associated with a known road feature, such as a speed bump, pothole, or other road feature that generates a measurable suspension excitation response. In some aspects, road features may be additionally (or alternatively) identified using map information that includes indications of various road features. In such instances, the map information may include map information/data that is collected by, or that has been augmented using, sensor data collected by one or more AVs operating in the environment containing the various road features. By way of example, various road features may be identified based on a correspondence between the map data and road feature locations identified by an AV localization system; depending on the desired implementation, such road feature identifications can be made by the mapping and localization stack 114.

Sensor data may include accelerometer measurements collected from accelerometers mounted on body panels of an AV. Sensor data may also include audio data collected from microphones mounted within the AV that are located to capture audio signals related to a suspension system. The sensor data may include measurements, images, and other data associated with the suspension system of the AV as well as the environment around the AV. The historical sensor data may also provide measurements from before, during, and after the interaction with the known road feature. As discussed above, the sensor systems 204-208 may include an accelerometer system, a microphone system, and a camera system capable of capturing data relating to the operation of the suspension system of the AV.

At step 304, the data center 150 calculates a baseline using the historical sensor data received from the plurality of autonomous vehicles. In one example, the historical sensor data is used to identify and/or learn of behavior characteristics of a suspension system as experienced by a plurality of AVs. Thereafter, AVs experiencing suspension degradation can be identified for inspection and maintenance by a technician or mechanic, who can enter data regarding whether a repair was needed, the nature of the repair, and/or a rating of the severity of the damage. In one aspect, the data center 150 may receive maintenance data from a user device associated with a mechanic after the mechanic has evaluated the respective AV following an indication that there is a degraded suspension component requiring inspection or maintenance. Using the sensor data and the maintenance data, the data center 150 may create an algorithm (human programmed heuristics, a machine learning algorithm, etc.). The algorithm can receive sensor data from AVs following an interaction with a known road feature and classify the interaction as one that indicates a degraded suspension component requiring vehicle maintenance or one that does not require suspension maintenance and may further classify the interaction with a degree of degradation for a particular suspension component. In some embodiments, the algorithm may be a machine learning algorithm that takes various inputs, such as the sensor data, the maintenance data, AV speed at the time the road feature was traversed, and/or a classification of the suspension response to the known road feature. In one aspect, the algorithm may be used to calculate a baseline or nominal range that would be expected for a healthy suspension system for a particular road feature. The data center 150 may send the algorithm and/or the baseline to AVs so that individual AVs can make determinations regarding the health and status of their suspension systems. The AV would thus receive from the remote data center the algorithm for the identification of the degraded suspension component.

At step 306, the local computing device 110 or data center 150 may determine a threshold measurement based on the calculated baseline. For example, for an accelerometer located near a rear shock absorber of an AV that is going over a particular speed bump at a particular street, a corresponding nominal range or baseline for the accelerometer would be calculated using the algorithm. Based on the output, threshold measurement values would be determined that are indicative of a degraded shock absorber. The threshold measurement values may be identified using historical sensor data and maintenance data.

At step 308, the threshold measurement values are associated to the particular road feature. In this case, if the accelerometer located at the rear shock absorber outputs a measurement that exceeds the threshold measurement values associated with the particular speed bump at the particular street, then an indication could be made that the rear shock absorber is degraded and in need of maintenance or replacement.

At step 310, the AV collects sensor data from sensors mounted directly on the AV. The sensor data includes a plurality of measurements from the sensors. For example, the sensors may be three-axis accelerometers mounted in proximity to suspension systems corresponding to each wheel. Alternatively, sensors may be an IMU mounted centrally to the AV that collects sensor data including roll, yaw, pitch, and vertical displacement measurements. Sensor data may also include audio data collected from microphones and/or image data collected from cameras. To enable comparison with a baseline for a known road feature, the collected sensor data is associated with the same known road feature. In other words, the sensor data relates to measurements captured while the AV traverses the known road feature.

At step 312, the AV identifies at least one measurement from the sensor data that is outside of the threshold measurements. The at least one measurement may be indicative of a degraded suspension component. For example, the accelerometer may have a threshold measurement two seconds of oscillation. Thus, when the AV drives over a speed bump, the accelerometer may output a periodic oscillation of five seconds thereby exceeding the threshold measurement. In other words, the autonomous vehicle identifies that the measured oscillation is outside or exceeds the threshold oscillation thereby signifying poor shock absorption and dampening. As discussed above, the threshold measurement is based on an expected oscillation response for that particular speed bump that was determined based on historical sensor data collected from numerous AVs.

At step 314, the AV identifies a location on the AV of the degraded suspension component based on the sensor data. Specifically, because sensors are located at each wheel to obtain measurements for their respective suspension systems, the AV is able to identify the location on the AV in which the degraded suspension component is located. In embodiments where the sensor is centrally located, such as an IMU, sensor data including roll, yaw, and pitch may be used to identify the appropriate AV location, e.g., right front, left front, right rear, or left rear.

In some embodiments, the AV may collect additional sensor data from other sensors 206, 208 to validate the presence of a degraded suspension component. For example, at step 316, the AV may collect audio data from a microphone 206 mounted in proximity to the identified suspension system of the AV and process the audio data associated with the road feature to identify audio signatures that are consistent with a degraded suspension component. Thus, the AV may initiate a request to collect sensor data from other sensors to validate the initial indication that a particular suspension component is degraded or failing by determining whether other sensor measurements also exceed or fall below a threshold value or measurement.

At step 318, the AV validates the indication of a degraded suspension component and/or the location of the degraded suspension component. Specifically, the AV validates the indication of a degraded suspension component and/or the location of the degraded suspension component by determining whether the audio data includes audio signatures that are consistent with a degraded suspension component.

In other embodiments, the AV may collect visual data from a camera 208 on the AV to validate the presence of a degraded suspension component. The AV may process visual data associated with the road feature to identify image characteristics that are consistent with a rough ride experience, such as blurred images. Blurred images that are incident to the road feature may indicate that the suspension system is not adequately dampening or absorbing known road features. The AV may thus validate the indication of a degraded suspension component and/or the location of the degraded suspension component by determining whether the visual data includes image degradation.

The method 300 provide efficiencies in identifying degraded suspension components without requiring manual inspection that is costly, time consuming, and inefficient. By utilizing known road features to determine whether sensor data is within nominal ranges or falls outside of threshold measurements, degraded suspension components can be monitored periodically in an efficient manner and initial indications of the presence of a degraded suspension component can be validated using sensor data from microphones or cameras. Where a degraded suspension component is confirmed, the data center 150 may send instructions to have the AV inspected and repaired without needing to rely on pre-determined inspection intervals. The AV can communicate with the remote data center 150 to confirm servicing is needed, and schedule servicing either immediately or in the future, depending on the necessity of the repair.

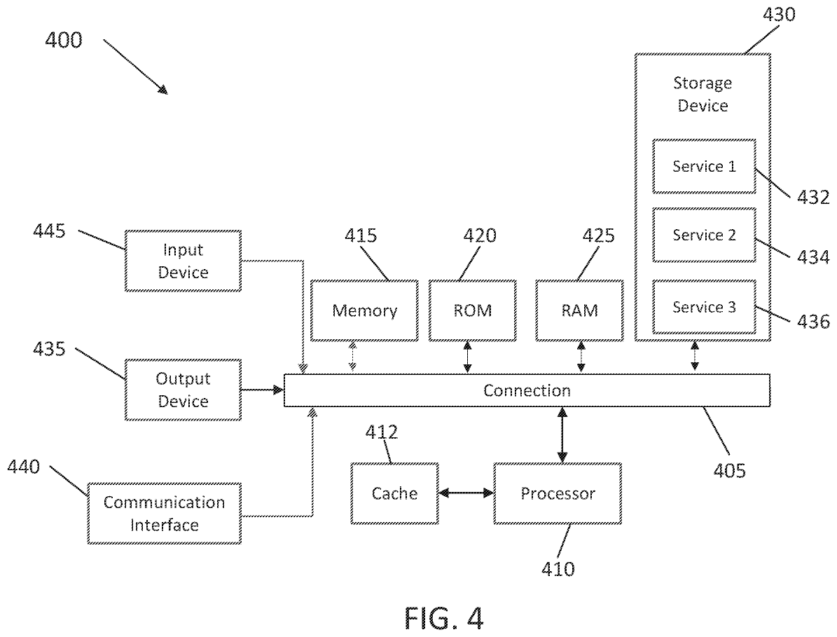

FIG. 4 illustrates an example apparatus (e.g., a processor-based system) with which some aspects of the subject technology can be implemented. For example, processor-based system 400 can be any computing device making up internal computing system 110, remote computing system 150, a passenger device executing the rideshare app 170, or any component thereof in which the components of the system are in communication with each other using connection 405. Connection 405 can be a physical connection via a bus, or a direct connection into processor 410, such as in a chipset architecture. Connection 405 can also be a virtual connection, networked connection, or logical connection.

Computing system 400 can be (or may include) a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices.

Example system 400 includes at least one processing unit (CPU or processor) 410 and connection 405 that couples various system components including system memory 415, such as read-only memory (ROM) 420 and random-access memory (RAM) 425 to processor 410. Computing system 400 can include a cache of high-speed memory 412 connected directly with, in close proximity to, or integrated as part of processor 410.

Processor 410 can include any general-purpose processor and a hardware service or software service, such as services 432, 434, and 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction, computing system 400 includes an input device 445, which can represent any number of input mechanisms, such as a microphone for speech, a touch-sensitive screen for gesture or graphical input, keyboard, mouse, motion input, speech, etc. Computing system 400 can also include output device 435, which can be one or more of a number of output mechanisms known to those of skill in the art. In some instances, multimodal systems can enable a user to provide multiple types of input/output to communicate with computing system 400. Computing system 400 can include communications interface 440, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 440 may also include one or more Global Navigation Satellite System (GNSS) receivers or transceivers that are used to determine a location of the computing system 400 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 430 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a Blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L6), resistive random-access memory (RRAM/ReRAM), phase change memory (PCM), spin transfer torque RAM (STT-RAM), another memory chip or cartridge, and/or a combination thereof.

Storage device 430 can include software services, servers, services, etc., that when the code that defines such software is executed by the processor 410, it causes the system to perform a function. In some embodiments, a hardware service that performs a particular function can include the software component stored in a computer-readable medium in connection with the necessary hardware components, such as processor 410, connection 405, output device 435, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A computer-implemented method for detecting a degraded suspension component, comprising:
associating a threshold measurement to a road feature;
collect sensor data from at least one sensor on an autonomous vehicle, wherein the sensor data includes a plurality of measurements from the at least one sensor, the sensor data associated with the road feature;
identify, from the sensor data, at least one measurement from the plurality of measurements that is outside of the threshold measurement and indicative of a degraded suspension component of the autonomous vehicle; and
identify a location on the autonomous vehicle of the degraded suspension component based on the sensor data.

2. The computer-implemented method of claim 1, further comprising:
analyzing historical sensor data collected from a plurality of autonomous vehicles, the historical sensor data associated with the road feature;
calculating a baseline using the historical sensor data received from the plurality of autonomous vehicles; and
determining the threshold measurement based on the calculated baseline.

3. The computer-implemented method of claim 1, further comprising:
sending the sensor data to a remote data center; and
receiving from the remote data center an algorithm for identifying the degraded suspension component, wherein the algorithm is trained from a collection of historical sensor data received from a plurality of autonomous vehicles, and wherein the sensor data received from a plurality of autonomous vehicles is labeled with classifications based on a degree of degradation for a particular suspension component.

4. The computer-implemented method of claim 1, further comprising:
collecting audio data from a microphone on the autonomous vehicle, the audio data associated with the road feature; and
validating the location of the degraded suspension component by determining whether the audio data includes audio signatures indicative of degraded suspension components.

5. The computer-implemented method of claim 1, further comprising:
collecting visual data from a camera on the autonomous vehicle, the visual data associated with the road feature; and
validating the indication of the degraded suspension component by determining whether the visual data includes image degradation.

6. The computer-implemented method of claim 1, further comprising identifying the road feature using map data.

7. The computer-implemented method of claim 1, wherein the road feature is a speed bump.

8. The computer-implemented method of claim 1, wherein the sensor is an accelerometer mounted on a body panel of the autonomous vehicle.

9. A non-transitory computer-readable storage medium comprising at least one instruction for causing a computer or processor to:
associate a threshold measurement to a road feature;
collect sensor data from a sensor on an autonomous vehicle, wherein the sensor data includes a plurality of measurements from the at least one sensor, the sensor data associated with the road feature;
identify, from the sensor data, at least one measurement from the plurality of measurements that is outside of the threshold measurement and indicative of a degraded suspension component of the autonomous vehicle; and
identify a location on the autonomous vehicle of the degraded suspension component based on the sensor data.

10. The non-transitory computer-readable storage medium of claim 9, wherein the instructions are further configured to cause the computer or processor to:
analyze historical sensor data collected from a plurality of autonomous vehicles, the historical sensor data associated with the road feature;
calculate a baseline using the historical sensor data received from the plurality of autonomous vehicles; and
determine the threshold measurement based on the calculated baseline.

11. The non-transitory computer-readable storage medium of claim 9, wherein the instructions are further configured to cause the computer or processor to:
send the sensor data to a remote data center; and
receive from the remote data center an algorithm for identifying the degraded suspension component, wherein the algorithm is trained from a collection of historical sensor data received from a plurality of autonomous vehicles, and wherein the sensor data received from a plurality of autonomous vehicles is labeled with classifications based on a degree of degradation for a particular suspension component.

12. The non-transitory computer-readable storage medium of claim 9, wherein the instructions are further configured to cause the computer or processor to:
collect audio data from a microphone on the autonomous vehicle, the audio data associated with the road feature; and
validate the location of the degraded suspension component by determining whether the audio data includes audio signatures indicative of degraded suspension components.

13. The non-transitory computer-readable storage medium of claim 9, wherein the instructions are further configured to cause the computer or processor to:
collect visual data from a camera on the autonomous vehicle, the visual data associated with the road feature; and
validate the indication of the degraded suspension component by determining whether the visual data includes image degradation.

14. The non-transitory computer-readable storage medium of claim 9, wherein the instructions are further configured to cause the computer or processor to identify the road feature using map data.

15. A system comprising:
at least one processor; and
at least one memory storing computer-readable instructions that, when executed by the at least one processor, causes the at least one processor to:
associate a threshold measurement to a road feature;
collect sensor data from a sensor on an autonomous vehicle, wherein the sensor data includes a plurality of measurements from the at least one sensor, the sensor data associated with the road feature;
identify, from the sensor data, at least one measurement from the plurality of measurements that is outside of the threshold measurement and indicative of a degraded suspension component of the autonomous vehicle; and
identify a location on the autonomous vehicle of the degraded suspension component based on the sensor data.

16. The system of claim 15, wherein the instructions are further configured to cause the at least one processor to:
analyze historical sensor data collected from a plurality of autonomous vehicles, the historical sensor data associated with the road feature;
calculate a baseline using the historical sensor data received from the plurality of autonomous vehicles; and
determine the threshold measurement based on the calculated baseline.

17. The system of claim 15, wherein the instructions are further configured to cause the at least one processor to:
send the sensor data to a remote data center; and
receive from the remote data center an algorithm for identifying the degraded suspension component, wherein the algorithm is trained from a collection of historical sensor data received from a plurality of autonomous vehicles, and wherein the sensor data received from a plurality of autonomous vehicles is labeled with classifications based on a degree of degradation for a particular suspension component.

18. The system of claim 15, wherein the instructions are further configured to cause the at least one processor to:
collect audio data from a microphone on the autonomous vehicle, the audio data associated with the road feature; and
validate the location of the degraded suspension component by determining whether the audio data includes audio signatures indicative of degraded suspension components.

19. The system of claim 15, wherein the instructions are further configured to cause the at least one processor to:
collect visual data from a camera on the autonomous vehicle, the visual data associated with the road feature; and
validate the indication of the degraded suspension component by determining whether the visual data includes image degradation.

20. The system of claim 15, wherein the instructions are further configured to cause the at least one processor to identify the road feature using map data.
